(19) United States
(12) Patent Application Publication
(10) Pub. No.: US 2026/0121691 A1
(43) Pub. Date: Apr. 30, 2026

(54) METHOD AND APPARATUS FOR DETERMINING DIRECTION OF RECONFIGURABLE INTELLIGENT SURFACE

(71) Applicant: Electronics and Telecommunications Research Institute, Daejeon (KR)

(72) Inventors: Song NOH, Incheon-si (KR); Young Seog SONG, Daejeon (KR); Eun-Young CHOI, Daejeon (KR); Jeongwon JEON, Bucheon-si (KR); Gaeun CHOI, Siheung-si (KR); Kyungsik SEO, Gwangmyeong-si (KR)

(21) Appl. No.: 19/003,283

(22) Filed: Dec. 27, 2024

(30) Foreign Application Priority Data
Mar. 21, 2024 (KR) 10-2024-0039419

(51) Int. Cl. H04B 7/04; H04B 7/06; H04L 25/02

(52) U.S. Cl. CPC H04B 7/04013; H04B 7/0617; H04L 25/0204

(57) ABSTRACT

A method of a base station may comprise: configuring a reflection pattern in which reflective elements in at least one row of an RIS node are activated during a unit time, and then reflective elements in at least one column of the RIS are activated during a unit time; transmitting configuration information on the reflection pattern to the RIS node; receiving, from the RIS node, signals including pilot symbols reflected according to the configured reflection pattern; separating the signals received during the unit time into first reception signals in a first direction and second reception signals in a second direction; estimating a first channel in the first direction by using the first reception signals; estimating a second channel in the second direction by using the second reception signals; and detecting a direction of the RIS node using the first channel and the second channel.

### CROSS-REFERENCE TO RELATED APPLICATIONS

This application claims priority to Korean Patent Applications No. 10-2024-0039419, filed on Mar. 21, 2024, with the Korean Intellectual Property Office (KIPO), the entire contents of which are hereby incorporated by reference.

### BACKGROUND

### 1. Technical Field

The present disclosure relates to a technique for determining a direction of a reconfigurable intelligent surface (RIS), and more particularly, to a technique for determining the direction of the RIS, which facilitates determination of the direction of the RIS considering Doppler effects for signals received during a unit time.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, millimeter-wave (mmWave) communication may be one of core technologies of 5G communication systems. Due to its wider signal bandwidth, mm Wave can achieve high data rates and high spectrum efficiency. However, mmWave may suffer from a severe path loss and blockage of a line of sight between communication devices. A reconfigurable intelligent surface (RIS) may be a technology that can improve the performance of such mmWave wireless communication. The RIS has a structure composed of low-cost passive elements, capable of effectively controlling a propagation channel by reflecting incoming signals. By utilizing the RIS, a base station and a terminal can form an indirect path even when a direct communication path is blocked. As a result, the base station and terminal can overcome signal attenuation and blockage issues that arise in mm Wave communication and mobile environments. To achieve this, accurate channel state information between the base station, RIS, and terminal may be required. However, estimating channel state information may be challenging in mobile environments due to the operational characteristics of passive element-based RIS.

### SUMMARY

The present disclosure for resolving the above-described problems is directed to providing a method and apparatus for determining a direction of a reconfigurable intelligent surface, which facilitate determination of the direction by separating signals received during a unit time into vertical-direction signals and horizontal-direction signals and considering Doppler effects therefor.

According to a first exemplary embodiment of the present disclosure, a method of a base station may comprise: configuring a reflection pattern in which reflective elements in at least one row of a reconfigurable intelligent surface (RIS) node are activated during a unit time, and then reflective elements in at least one column of the RIS are activated during a unit time; transmitting configuration information on the reflection pattern to the RIS node; receiving, from the RIS node, signals including pilot symbols reflected according to the configured reflection pattern; separating the signals received during the unit time into first reception signals in a first direction and second reception signals in a second direction; estimating a first channel in the first direction by using the first reception signals; estimating a second channel in the second direction by using the second reception signals; and detecting a direction of the RIS node using the first channel and the second channel.

The reflection pattern may be a pattern formed by sequentially activating the reflective elements in the at least one row of the RIS node while shifting in the first direction, and then sequentially activating the reflective elements in the at least one column of the RIS node while shifting in the second direction.

The first reception signals may be signals reflected by the reflective elements in the at least one row of the RIS node during the unit time, and the second reception signals may be signals reflected by the reflective elements in the at least one column of the RIS node during the unit time.

The base station may estimate the first channel from the first reception signals and may estimate the second channel from the second reception signals by using one of an atomic norm minimization technique, a multiple signal classification (MUSIC) algorithm, or a root-MUSIC algorithm.

The detecting of the direction of the RIS node may comprise: calculating angles of arrivals (AoAs) of signals received from the RIS node using the first channel and the second channel; calculating effective angles of departure (AoDs) at the RIS node for the signals received from the RIS node using the first channel and the second channel; and detecting the direction of the RIS node using the AoAs and the AoDs.

The base station may calculate the AoAs and the AoDs from the first channel and the second channel using one of a single component analysis algorithm, a MUSIC algorithm or a root-MUSIC algorithm.

The method may further comprise: calculating a gain for the first channel and a gain for the second channel using the AoAs and the AoDs.

The method may further comprise: estimating a Doppler shift component for the first channel and a Doppler shift component for the second channel using the AoAs and the AoDs.

According to a second exemplary embodiment of the present disclosure, a base station may comprise a processor, and the processor may cause the base station to perform: configuring a reflection pattern in which reflective elements in at least one row of a reconfigurable intelligent surface (RIS) node are activated during a unit time, and then reflective elements in at least one column of the RIS are activated during a unit time; transmitting configuration information on the reflection pattern to the RIS node; receiving, from the RIS node, signals including pilot symbols reflected according to the configured reflection pattern; separating the signals received during the unit time into first reception signals in a first direction and second reception signals in a second direction; estimating a first channel in the first direction by using the first reception signals; estimating a second channel in the second direction by using the second reception signals; and detecting a direction of the RIS node using the first channel and the second channel.

The reflection pattern may be a pattern formed by sequentially activating the reflective elements in the at least one row of the RIS node while shifting in the first direction, and then sequentially activating the reflective elements in the at least one column of the RIS node while shifting in the second direction.

The first reception signals may be signals reflected by the reflective elements in the at least one row of the RIS node during the unit time, and the second reception signals may be signals reflected by the reflective elements in the at least one column of the RIS node during the unit time.

The base station may estimate the first channel from the first reception signals and may estimate the second channel from the second reception signals by using one of an atomic norm minimization technique, a multiple signal classification (MUSIC) algorithm, or a root-MUSIC algorithm.

In the detecting of the direction of the RIS node, the processor may cause the base station to perform: calculating angles of arrivals (AoAs) of signals received from the RIS node using the first channel and the second channel; calculating effective angles of departure (AoDs) at the RIS node for the signals received from the RIS node using the first channel and the second channel; and detecting the direction of the RIS node using the AoAs and the AoDs.

The base station may calculate the AoAs and the AoDs from the first channel and the second channel using one of a single component analysis algorithm, a MUSIC algorithm or a root-MUSIC algorithm.

According to the present disclosure, a base station can separate signals received during a unit time into vertical-direction signals and horizontal-direction signals. Additionally, according to the present disclosure, the base station can determine a direction of a reconfigurable intelligent surface (RIS) by considering Doppler effects using the vertical-direction signals and horizontal-direction signals. The present disclosure can allow the base station to determine the direction of the RIS using the vertical-direction and horizontal-direction signals, thereby reducing computational complexity.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a communication system supporting an aerial RIS.

FIG. 4 is a flowchart illustrating a first exemplary embodiment of a direction determination method for an RIS node.

FIG. 5 is a conceptual diagram illustrating a first exemplary embodiment of a method for activating reflective elements of an RIS in a vertical direction.

FIG. 6 is a conceptual diagram illustrating a first exemplary embodiment of a method for activating reflective elements of an RIS in a horizontal direction.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

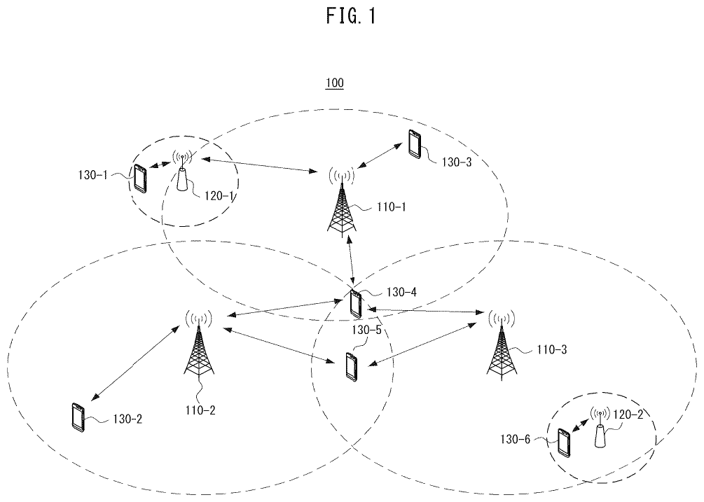

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

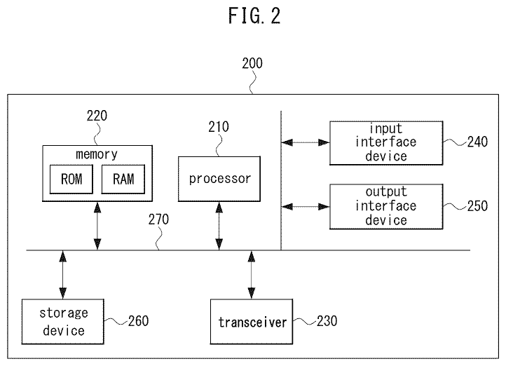

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Millimeter-wave (mmWave) communication is one of core technologies of 5G communication systems. Due to its wider signal bandwidth, mmWave can achieve high data rates and high spectrum efficiency. However, mm Wave may suffer from a severe path loss and blockage of a line of sight between communication devices. A reconfigurable intelligent surface (RIS) may be a technology that can improve the performance of such mm Wave wireless communication.

The RIS has a structure composed of low-cost passive elements, capable of effectively controlling a propagation channel by reflecting incoming signals. By utilizing the RIS, a base station and a terminal can form an indirect path even when a direct communication path therebetween is blocked. As a result, the base station and terminal can overcome signal attenuation and blockage issues that arise in mmWave communication and mobile environments. However, to achieve this, accurate channel state information between the base station, RIS, and terminal may be required. Estimating channel state information may be challenging in mobile environments due to the operational characteristics of passive element-based RIS.

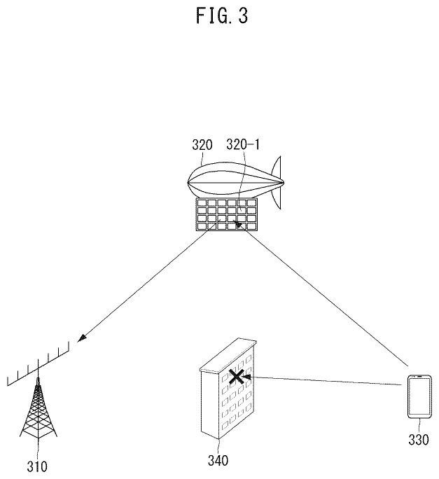

FIG. 3 is a conceptual diagram illustrating a first exemplary embodiment of a communication system supporting an aerial RIS.

Referring to FIG. 3, a communication system may include a base station 310, an aerial RIS node 320, and a terminal 330. Here, the aerial RIS node 320 may include multiple reflective elements 320-1.

In the communication system, the aerial RIS node may be connected to the base station through a wired or wireless control link. The aerial RIS node may reflect downlink (DL) signals incident on its reflective elements to the terminal by appropriately adjusting phases of the reflective elements under control of the base station. Similarly, the aerial RIS node may reflect uplink (UL) signals incident from the terminal to the base station by appropriately adjusting phases of the reflective elements under control of the base station.

Thus, the communication system may establish an auxiliary transmission link between the base station and the terminal by arranging the aerial RIS node at an appropriate location between them. This allows for continuous communication through the auxiliary link in cases where a direct link is blocked by an obstacle 340.

Here, the communication system may be a narrowband terrestrial communication system supported by the aerial RIS node. In this case, the base station may be equipped with a receiver comprising M antennas arranged in a uniform linear array (ULA). The terminal may be equipped with a transmitter comprising a single antenna. Here, M is a positive integer.

The base station and terminal may be terrestrial nodes. On the other hand, the aerial RIS node may be deployed in the air to support terrestrial nodes for coverage expansion in an environment where a direct transmitter-receiver link may be negligible due to a high path loss and blockage occurring at mm Wave frequencies.

The uniform planar array (UPA)-based RIS may comprise N reflective elements arranged in Nᵥ rows and Nₕ columns. Accordingly, N may be as shown in Equation 1, where N, Nᵥ, and Nₕ are positive integers.

$$N = {N}_{r} {N}_{h} \qquad [ Equation 1 ]$$

The terminal may continuously transmit signals including pilot symbols toward the RIS node. Then, the RIS node may reflect the signals including the pilot symbols, which are continuously incident from the terminal, toward the base station. Subsequently, the base station may continuously receive the signals including the pilot symbols from the RIS node.

In this case, the base station may generate a reception signal block from the reception signals including the pilot symbols that are received during a unit time. Here, the unit time may be defined as a time during which Nₚ pilot symbols are received. A symbol time may be defined as a time at which each pilot symbol is received and may be denoted as i. Here, Nₚ and i may be positive integers. In this case, the symbol time i may satisfy Equation 2 below.

$$i ∈ \{ 1 , … , {N}_{P} \} \qquad [ Equation 2 ]$$

Accordingly, the base station may receive a reception signal yᵢ at the symbol time i, as shown in Equation 3.

$${y}_{i} = {G}_{i} diag ( {ψ}_{i} ) {h}_{i} {x}_{i} + {n}_{i} = {G}_{i} diag ( {h}_{i} ) {ψ}_{i} {x}_{i} + {n}_{i} \qquad [ Equation 3 ]$$

Here, Gᵢ ∈ [symbol] ^{M×N} may be a channel between the base station and the aerial RIS node, and may be expressed as Equation 4 below.

$${G}_{i} = {\sum }_{ℓ = 1}^{{L}_{g}} {α}_{g , ℓ} {e}^{j 2 π ( i - 1 ) {v}_{g , ℓ}} {u}_{M} ( {ξ}_{g , ℓ} ) {u}_{N}^{H} ( {ϕ}_{g , ℓ} , {θ}_{g , ℓ} ) \qquad [ Equation 4 ]$$

hᵢ ∈ [symbol] ^{N} may be a channel between the terminal and the aerial RIS node, and may be expressed as Equation 5 below.

$${h}_{i} = {\sum }_{ℓ = 1}^{{L}_{h}} {α}_{h , ℓ} {e}^{j 2 π ( i - 1 ) {v}_{h , ℓ}} {u}_{N} ( {ϕ}_{h , ℓ} , {θ}_{h , ℓ} ) \qquad [ Equation 5 ]$$

In this case, [symbol] may be a path gain in a path between the [symbol] -th reflective element of the RIS node and the base station. [symbol] may be a Doppler shift coefficient in the path between the f-th reflective element of the RIS node and the base station. [symbol] may be a spatial frequency related to an angle of arrival (AoA) of signals reaching the base station in the path between the [symbol] -th reflective element of the RIS node and the base station. In addition, { [symbol] } may be a spatial frequency related to an angle of departure (AoD) of signals reflected at the [symbol] -th reflective element of the RIS node in the path between the [symbol] -th reflective element of the RIS node and the base station, and may be expressed as {elevation, azimuth}.

Meanwhile, [symbol] may be a path gain in a path between the [symbol] -th reflective element of the aerial RIS node and the terminal. In addition, [symbol] may denote a Doppler shift coefficient in the path between the t-th reflective element of the aerial RIS node and the terminal. Furthermore, { [symbol] } may be a spatial frequency related to an AoA of signals at the terminal in the path between the [symbol] -th reflective element of the RIS node and the terminal, and may be expressed as {elevation, azimuth}. In addition, L_{g} may denote the number of channel paths between the aerial RIS node and the base station. Lₕ may denote the number of channel paths between the aerial RIS node and the terminal.

In particular, a spatial frequency component [symbol] may be defined as a physical angle as shown in [symbol] ∈(0, π). Similarly, a spatial frequency component [symbol] may be defined as a physical angle as shown in [symbol] ∈(0, π). Additionally, a spatial frequency component [symbol] may be defined as a physical angle as shown in [symbol] ∈(0, π). Moreover, a spatial frequency component [symbol] may be defined as a physical angle as shown in [symbol] ∈(0, π). Furthermore, a spatial frequency component [symbol] may be defined as a physical angle as shown in [symbol] ∈(0, π). Accordingly, Equations 6 to 8 may be established.

$${ξ}_{g , ℓ} = cos ( {ξ}_{g , ℓ}^{⋁} ) \qquad [ Equation 6 ]$$

$${ϕ}_{g , ℓ} = cos ( {{ϕ}^{⋁}}_{g , ℓ} ) sin ( {{θ}^{⋁}}_{g , ℓ} ) \qquad [ Equation 7 ]$$

$${θ}_{g , ℓ} = cos ( {{θ}^{⋁}}_{g , ℓ} ) \qquad [ Equation 8 ]$$

Meanwhile, ψᵢ∈ [symbol] ^{N} may denote a phase shift of the aerial RIS node and may be expressed as Equation 9.

$${ψ}_{i} = {[ e \text{?} , … , e \text{?} ]}^{T} \qquad [ Equation 9 ]$$

$$\text{?} \text{indicates text missing or illegible when filed}$$

Additionally, xᵢ may denote a pilot symbol subject to a transmission power constraint, as shown in Equation 10 below.

$${\vert {x}_{i} \vert}^{2} = ρ \qquad [ Equation 10 ]$$

Furthermore,

$${n}_{i} ∼ 𝒞𝒩 ( 0 , {σ}_{n}^{2} {I}_{M} )$$

may denote a complex Gaussian noise vector with a mean of 0 and variance of

$${σ}_{n}^{2} .$$

Since the communication system including the RIS node operates in the millimeter-wave frequency band, a geometry-based sparse channel model may be adopted.

Meanwhile, channel parameters may remain nearly constant within each block. The aerial RIS node may move at a speed of V km/h. Accordingly, a fading channel may be a quasi-static block fading channel. Here, V may denote a speed of the aerial RIS node and may be a real number.

Thus, a channel between the aerial RIS node and the base station may be affected by Doppler shift as defined in Equation 11 below.

$${υ}_{g , ℓ} = \frac{υ}{λ} cos ( \text{?} ) sin ( \text{?} ) T \qquad [ Equation 11 ]$$

$$\text{?} \text{indicates text missing or illegible when filed}$$

Additionally, a channel between the aerial RIS node and the terminal may be affected by Doppler shift as defined in Equation 12.

$${υ}_{h , ℓ} = \frac{υ}{λ} cos ( \text{?} ) sin ( \text{?} ) T \qquad [ Equation 12 ]$$

$$\text{?} \text{indicates text missing or illegible when filed}$$

Here, λ may denote a wavelength of the signal, and T may denote a symbol duration.

M antennas of the base station may be installed with half-wavelength spacing. In a uniform linear array (ULA) of M antennas at the base station, an array response vector may be expressed as Equation 13 below.

$${u}_{M} ( {ξ}_{g , ℓ} ) = {[ 1 , \text{?} , … , \text{?} ]}^{T} \qquad [ Equation 13 ]$$

$$\text{?} \text{indicates text missing or illegible when filed}$$

The N reflective elements of the aerial RIS node may be installed with half-wavelength spacing. In this case, an array response vector for the UPA of N reflective elements of the aerial RIS node, in relation to the aerial RIS node and the base station, may be expressed as shown in Equation 14 or Equation 15.

$${u}_{N} ( {ϕ}_{g , ℓ} , {θ}_{g , ℓ} ) = \text{?} ( {ϕ}_{g , ℓ} ) ⊗ ( {θ}_{g , ℓ} ) \qquad [ Equation 14 ]$$

$${u}_{N} ( \text{?} ) = {[ 1 , \text{?} , … , \text{?} ]}^{T} ⊗ {[ 1 , \text{?} , … , \text{?} ]}^{T} \qquad [ Equation 15 ]$$

$$\text{?} \text{indicates text missing or illegible when filed}$$

Meanwhile, an array response vector u_{N} ( [symbol] ) of the UPA of N reflective elements of the aerial RIS node, in relation to the aerial RIS node and the terminal, may similarly be defined. The aerial RIS node may be located at a high altitude to ensure line-of-sight (LoS) communication between the aerial RIS node and the terrestrial nodes. Therefore, the present disclosure may utilize a path loss model based on a Rician K factor K_{g}, defined by Equations 16 and 17. In Equation 17, [symbol] may not be equal to 1.

$$\vert {α}_{g , 1} \vert = \sqrt{\frac{{κ}_{g}}{1 + {κ}_{g}}} \qquad [ Equation 16 ]$$

$$\vert {α}_{g , ℓ} \vert = \sqrt{\frac{{κ}_{g}}{1 + {κ}_{g}}} \qquad [ Equation 17 ]$$

Meanwhile, based on the channel model of Equations 4 and 5, the reception signal in Equation 3 may equivalently be expressed as shown in Equation 18 below.

$$\begin{matrix}{y}_{i} = ( \text{?} {u}_{M} ( \text{?} ) \text{?} \times \text{?} ( \text{?} - \text{?} , \text{?} - \text{?} ) ) {ψ}_{i} {x}_{i} + {n}_{i} \\ = ( \text{?} {u}_{M} ( \text{?} ) \text{?} ( \text{?} ) ) {ψ}_{i} {x}_{i} + {n}_{i}\end{matrix} \qquad [ Equation 18 ]$$

$$\text{?} \text{indicates text missing or illegible when filed}$$

Here, [symbol] may be as shown in Equation 19 below. Cascaded channel parameters may be as shown in Equations 20 to 23. Here, [symbol] may range from 1 to L_{g} and may denote a channel path index between the aerial RIS node and the base station. Additionally, [symbol] may range from 1 to Lₕ and may denote a channel path index between the aerial RIS node and the terminal. Furthermore, [symbol] may denote a path gain in the channel [symbol] , and [symbol] may denote a path gain in the channel [symbol] ″. Additionally, [symbol] may denote a Doppler shift coefficient in the channel [symbol] , and [symbol] may denote a Doppler shift coefficient in the channel [symbol] . In addition, [symbol] may denote a spatial frequency related to an AoD of signals of the RIS in the channel [symbol] and may be an elevation. [symbol] may denote a spatial frequency related to an AoA of signals of the aerial RIS node in the channel [symbol] ″ and may be an elevation. Additionally, [symbol] may denote a spatial frequency related to an AoD of signals of the RIS in the channel [symbol] and may be an azimuth. [symbol] may denote a spatial frequency related to an AoA of signals of the aerial RIS node in the channel [symbol] ″ and may be an azimuth.

$$ℓ := ( {ℓ}^{′} - 1 ) \text{?} + {ℓ}^{″} \qquad [ Equation 19 ]$$

$${α}_{ℓ} := \text{?} \qquad [ Equation 20 ]$$

$${v}_{ℓ} := {v}_{g , {ℓ}^{′}} + \text{?} \qquad [ Equation 21 ]$$

$${ϕ}_{ℓ} := {ϕ}_{g , {ℓ}^{′}} - \text{?} \qquad [ Equation 22 ]$$

$${θ}_{ℓ} := {θ}_{g , {ℓ}^{′}} - \text{?} \qquad [ Equation 23 ]$$

$$\text{?} \text{indicates text missing or illegible when filed}$$

A cascaded path gain may calculated as a product of individual path gains. Therefore, only a path formed as a cascade of LOS paths in both channels may be dominant among these cascaded paths. The remaining paths connected to weak non-line-of-sight (NLOS) paths in one or both channels may generally experience significant attenuation on an order of tens of dB. Accordingly, a focus may be on estimating the spatial frequency ξ_{g,1}, φ₁, and θ₁, which is related to a single LOS path connecting the terminal, aerial RIS node, and base station that primarily contributes to a reception power. Methods proposed in the present disclosure may be channel estimation techniques with low overhead, even in the presence of Doppler effects.

First, the reception signal in Equation 18 may alternatively be expressed as shown in Equation 24 below.

$${y}_{i} = {U}_{M} ( {ξ}_{g} ) ( ( \text{?} ⊗ \text{?} ) diag ( α ) \{ diag ( \text{?} ) ⊙ [ \text{?} ( ϕ , θ ) {ψ}_{i} ] \} ) {x}_{i} + {n}_{i} , \qquad [ Equation 24 ]$$

$$\text{?} \text{indicates text missing or illegible when filed}$$

In this case, α may be as shown in Equation 25, ξ_{g} may be as shown in Equation 26, φ may be as shown in Equation 27, and θ may be as shown in Equation 28. Here, L may be L_{g}Lₕ.

$$α = {[ \text{?} , … , \text{?} ]}^{T} \qquad [ Equation 25 ]$$

$$\text{?} = {[ \text{?} , … , \text{?} ]}^{T} \qquad [ Equation 26 ]$$

$$ϕ = {[ {ϕ}_{1} , … , {ϕ}_{L} ]}^{T} \qquad [ Equation 27 ]$$

$$θ = {[ {θ}_{1} , … , {θ}_{L} ]}^{T} \qquad [ Equation 28 ]$$

$$\text{?} \text{indicates text missing or illegible when filed}$$

An array response vector U_{N}(ξ_{g}) at the base station may be as shown in Equation 29.

$${U}_{M} ( {ξ}_{g} ) = [ {u}_{M} ( {ξ}_{g , 1} ) , … , {u}_{M} ( {ξ}_{g} \text{?} ) ] \qquad [ Equation 29 ]$$

$$\text{?} \text{indicates text missing or illegible when filed}$$

An array response vector U_{N}(φ,θ) at the aerial RIS node be as shown in Equation 30.

$${u}_{N} ( ϕ , θ ) = [ \text{?} ( \text{?} ) ⊗ \text{?} ( {θ}_{1} ) , … , \text{?} ( {ϕ}_{L} ) ⊗ \text{?} ( {θ}_{L} ) ] \qquad [ Equation 30 ]$$

$$\text{?} \text{indicates text missing or illegible when filed}$$

The reception signal Y observed during a unit time in Equation 24 may be expressed as shown in Equation 31.

$$Y = {U}_{M} ( {ξ}_{g} ) ( ( \text{?} ⊗ \text{?} ) diag ( α ) \times \{ \text{?} ( 2 v ) ⊙ [ \text{?} ( ϕ , θ ) Ψ ] \} ) X + N , \qquad [ Equation 31 ]$$

$$\text{?} \text{indicates text missing or illegible when filed}$$

In this case, [U_{N}_{ₚ}(2v)]_{m,n} may be as shown in Equation 32, v may be as shown in Equation 33, ψ may be as shown in Equation 34, X may be as shown in Equation 35, N may be as shown in Equation 36, and vec(N) may be as shown in Equation 37.

$${[ {U}_{{N}_{P}} ( 2 ν ) ]}_{m , n} = {e}^{j 2 π ( m - 1 ) {ν}_{n}} \qquad [ Equation 32 ]$$

$$ν = {[ {ν}_{1} , … , {ν}_{L} ]}^{T} \qquad [ Equation 33 ]$$

$$Ψ = [ {ψ}_{1} , … , {ψ}_{{N}_{P}} ] ∈ {ℂ}^{N \times {N}_{P}} \qquad [ Equation 34 ]$$

$$X = diag ( {x}_{1} , … , {x}_{{N}_{P}} ) . \qquad [ Equation 35 ]$$

$$N = [ {n}_{1} , … , {n}_{{N}_{P}} ] \qquad [ Equation 36 ]$$

$$vec ( N ) \sim 𝒞𝒩 ( {0}_{{MN}_{P}} , {σ}_{n}^{2} {I}_{{MN}_{P} )} \qquad [ Equation 37 ]$$

The combined spatial frequency estimation as described above may cause computational complexity due to interdependencies, as can be seen from Equation 31. To address this computational complexity, the present disclosure may utilize an activation-deactivation scheme for the reflective elements of the spatial RIS node based on a planar antenna array.

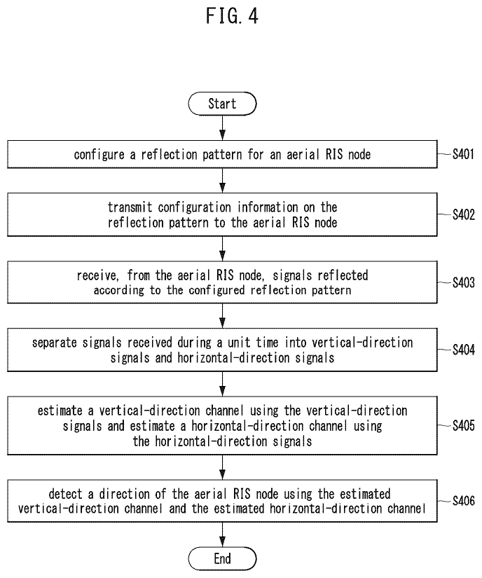

FIG. 4 is a flowchart illustrating a first exemplary embodiment of a direction determination method for an RIS node.

Referring to FIG. 4, in a direction determination method, the base station may configure a reflection pattern that is formed by activating reflective elements in at least one column of the RIS during a unit time and then activating reflective elements in at least one row during a unit time (S400).

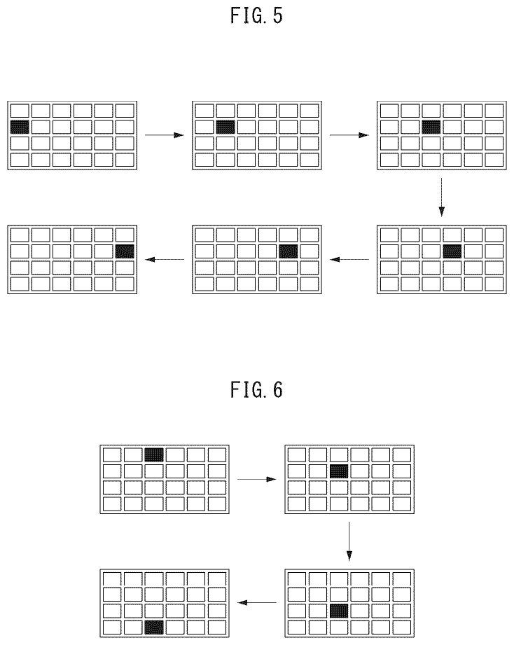

The reflection pattern formed described above may be a reflection pattern formed by sequentially activating reflective elements in at least one column of the RIS while shifting in a vertical direction during a unit time, as shown in FIG. 5, and by subsequently activating reflective elements in at least one row while shifting in a horizontal direction, as shown in FIG. 6. The reflection pattern may be expressed as shown in Equation 38.

$$Ψ = [ {1}_{R}^{T} ⊗ {Ψ}_{v} , {1}_{R}^{T} ⊗ {Ψ}_{h} ] ∈ {ℂ}^{N \times RN} \qquad [ Equation 38 ]$$

An intelligent reflection pattern Ψᵥ for the vertical direction in Equation 38 may be as shown in Equation 39. Here, nₕ may be defined as 1≤nₕ≤Nₕ. Additionally, an intelligent reflection pattern Ψₕ for the horizontal direction in Equation 38 may be as shown in Equation 40. Here, Ψₕ may be defined as 1≤nᵥ≤Nᵥ. Here, R may represent the number of repetitions for vertical/horizontal reflections. A training overhead required for the considered reflection pattern may be defined as N_{P}=R(Nₕ+Nᵣ).

$${Ψ}_{v} = {[ {I}_{{N}_{h}} ]}_{: , {n}_{h}} ⊗ {I}_{{N}_{v}} \qquad [ Equation 39 ]$$

$$\text{?} \qquad [ Equation 40 ]$$

$$\text{?} \text{indicates text missing or illegible when filed}$$

Meanwhile, the base station may transmit configuration information on the reflection pattern of the aerial RIS node to the aerial RIS node (S401). Then, the aerial RIS node may receive the configuration information for the reflection pattern from the base station. Meanwhile, the terminal may continuously transmit signals including pilot symbols toward the aerial RIS node. Then, the aerial RIS node may reflect the signals including the pilot symbols incident from the terminal toward the base station according to the configured reflection pattern. In this case, the aerial RIS node may reflect the signals including the pilot symbols received from the terminal toward the base station by sequentially activating reflective elements in at least one column while shifting in the vertical direction during a unit time. Additionally, the aerial RIS node may reflect the signals including the pilot symbols received from the terminal toward the base station by sequentially activating reflective elements in at least one row while shifting in the horizontal direction during a unit time.

Accordingly, the base station may receive the signals including pilot symbols reflected according to the configured reflection pattern from the aerial RIS node (S403). Further, the base station may separate the reception signals in the vertical direction reflected by the reflective elements in the at least one column of the aerial RIS node and the reception signals in the horizontal direction reflected by the reflective elements in the at least one row of the aerial RIS node (S404). Describing in more detail, the reflection pattern may separate the spatial frequencies in the vertical and horizontal directions as follows.

$$\text{?} \qquad [ Equation 41 ]$$

$$\text{?} \text{indicates text missing or illegible when filed}$$

In this case, Equations 42 and 43 may be established. Utilizing this property, the reception signal received during the unit time may be as shown in Equation 44.

$$\text{?} \qquad [ Equation 42 ]$$

$$\text{?} \qquad [ Equation 43 ]$$

$$\text{?} \qquad [ Equation 44 ]$$

$$\text{?} \text{indicates text missing or illegible when filed}$$

Here, X may be as shown in Equation 45. Additionally, ^{bkdiag(A.B)} may be a block diagonal matrix composed of main diagonal components, blocks A and B. Xᵥ and Xₕ may be pilot signals reflected in the vertical and horizontal directions by the aerial RIS node.

$$X = bkdiag ( {I}_{R} ⊗ {X}_{v} , {I}_{R} ⊗ {X}_{h} ) ; \qquad [ Equation 45 ]$$

A key point in Equation 44 is that a column space of Y existing in the spatial domain is transformed to be encompassed by U_{M}(ξ). On the other hand, a row space of Y existing in the spatial domain may be transformed to be encompassed by components U_{N}_{_{g}}(θ) and U_{N}_{ₕ}(φ) Therefore, the base station may separate the reception signals Y into the reception signals R_{N}_{ᵥ} in the vertical direction and the remaining reception signals RNₕ in the horizontal direction to estimate θ and φ. Accordingly, the base station may estimate a vertical-direction channel using the reception signals in the vertical direction and then estimate a horizontal-direction channel using the estimated vertical-domain channel (S405). The estimated vertical-direction channel \tilde{Y}ᵥ may be as shown in Equation 46, and the estimated horizontal-direction channel \tilde{Y}ₕ may be as shown in Equation 47. In this case, the base station may estimate the channel using techniques such as atomic norm minimization, multiple signal classification (MUSIC) algorithm, or root-MUSIC algorithm.

$$\begin{matrix}{\tilde{Y}}_{v} = \frac{1}{R} {\sum }_{p = 1}^{R} {[ Y ]}_{\\ : , ( p - 1 ) {N}_{v} + 1 : {pN}_{n}} \\ = {U}_{M} ( {ξ}_{g} ) ( {I}_{{L}_{g}} ⊗ \text{?} ) diag ( {\tilde{α}}_{v} ) {U}_{{N}_{v}}^{H} ( \tilde{θ} ) {X}_{v} + {\tilde{N}}_{v}\end{matrix} , \qquad [ Equation 46 ]$$

$$\begin{matrix}{\tilde{Y}}_{h} = \frac{1}{R} {\sum }_{p = 1}^{R} \text{?} \\ = {U}_{M} ( {ξ}_{g} ) ( {I}_{{L}_{g}} ⊗ {1}_{{L}_{h}}^{T} ) diag ( {\tilde{α}}_{h} ) {U}_{{N}_{h}}^{H} ( \tilde{ϕ} ) {X}_{h} + {\tilde{N}}_{h}\end{matrix} , \qquad [ Equation 47 ]$$

$$\text{?} \text{indicates text missing or illegible when filed}$$

Here, the parameters may be defined as shown in Equations 48 to 53. First, \tilde{θ} may be defined as shown in Equation 48, and + may be defined as shown in Equation 49. [symbol] may be defined as shown in Equation 50, and [symbol] may be defined as shown in Equation 51. Additionally, Ñᵥ may be defined as shown in Equation 52, and Ñₕ may be defined as shown in Equation 53.

$$\tilde{θ} = θ - 2 ν \qquad [ Equation 48 ]$$

$$\tilde{ϕ} = ϕ - 2 ν \qquad [ Equation 49 ]$$

$$\text{?} \qquad [ Equation 50 ]$$

$$\text{?} \qquad [ Equation 51 ]$$

$${\tilde{N}}_{v} = \text{?} \qquad [ Equation 52 ]$$

$$\text{?} \qquad [ Equation 53 ]$$

$$\text{?} \text{indicates text missing or illegible when filed}$$

Here, vec(Ñ_{b}) may be defined as

$$\text{?}$$

$$\text{?} \text{indicates text missing or illegible when filed}$$

and vec(Ñₕ) may be defined as

$$\text{?}$$

$$\text{?} \text{indicates text missing or illegible when filed}$$

A key point to note is that the preprocessed signals in Equations 46 and 47 may be equivalent if slight differences in the definition of path gains and angular parameters are taken into account. Therefore, the base station may focus on channel estimation of the vertical-direction signals in Equation 46 and directly apply the resulting algorithm to the horizontal-direction signals in Equation 47 for channel estimation.

Meanwhile, the base station may detect a direction of the aerial RIS node using the vertical-direction channel estimation and horizontal-direction channel estimation (S406). Describing this in more detail, the base station may calculate an AoA of the signals received from the aerial RIS node and an effective AoD of the signals at the aerial RIS node using the vertical-direction and horizontal-direction channel estimations. In this case, the base station may calculate the AoA of the signals received from the aerial RIS node and the AoD of the signals at the aerial RIS node, by using a single component analysis algorithm, MUSIC algorithm, root-MUSIC algorithm, etc. on the vertical-direction and horizontal-direction channel estimations, which are obtained through optimization based on an atomic norm minimization technique (i.e. semi-definite program).

One possible method in this context is as follows. That is, an approach for detecting the direction of the spatial RIS node may treat the one two-dimensional problem of ξ_{g,1} and \tilde{θ}₁ as two separate one-dimensional problems, estimating the channel parameters separately. However, this method may be a suboptimal solution, as it individually processes the reception signals using two semi-definite programming optimization tools. In contrast, the proposed approach may define an atomic set such that it consists of the desired signal components and leverage this to jointly utilize the structure of \tilde{Y}ᵥ. Here, if B is expressed as Equation 54 and [symbol] as Equation 55, the atomic norm of B may be as shown in Equation 56.

$$B := {{u}_{M} ( {ξ}_{g , 1} ) [ {\tilde{α}}_{v} ]}_{1} {u}_{{n}_{v}}^{H} ( {\tilde{θ}}_{1} ) ) \qquad [ Equation 54 ]$$

$$𝒜 = \{ A ( {φ}_{1} , {φ}_{2} ) = {u}_{M} ( {φ}_{1} ) {u}_{{N}_{v}}^{H} ( {φ}_{2} ) \vert {φ}_{1} , {φ}_{2} ∈ [ - 1 , 1 ] \} \qquad [ Equation 55 ]$$

$${‖ B ‖}_{𝒜} = inf \{ \vert {α}_{1} \vert \vert B = {a}_{1} A ( {φ}_{1} , {φ}_{2} ) , A ( {φ}_{1} , {φ}_{2} ) ∈ 𝒜 \} , \qquad [ Equation 56 ]$$

Additionally, the present disclosure may provide an atomic decomposition of B that achieves the atomic norm [symbol] under certain separation conditions. Therefore, the proposed approach for estimating ξ_{g,1} and \tilde{θ}₁ may be configured as an atomic norm minimization technique, which is expressed as [symbol] , where [symbol] depends on

$${‖ {\tilde{Y}}_{v} {X}_{v}^{- 1} - B ‖}_{F}^{2} \leq ϵ .$$

### Here,

$${‖ {\tilde{Y}}_{v} {X}_{v}^{- 1} - B ‖}_{F}^{2} \leq ϵ .$$

may be an optimizable hyperparameter. This atomic norm minimization technique can be effectively calculated using a semi-definite program and can be expressed as shown in Equation 57.

$${min}_{{u}_{ξ} , {u}_{\tilde{θ}} , B} tr ( T ( {u}_{ξ} ) ) + tr ( T ( {u}_{\tilde{θ}} ) ) \\ s . t . ( C \text{.1} ) [ \begin{matrix}T ( {u}_{ξ} ) & B \\ {B}^{H} & T ( {u}_{\tilde{θ}} )\end{matrix} ] ⪰ 0 and \\ ( C \text{.2} ) {‖ {\tilde{Y}}_{v} {X}_{v}^{- 1} - B ‖}_{F}^{2} \leq ϵ , \qquad [ Equation 57 ]$$

Here, tr(⋅) may represent a sum of the diagonal components of the matrix, and T(u) may represent a Hermitian-Toeplitz matrix with u as its first column. A trade-off between sparsity and noise degradation error term may be determined by introducing normalization parameters ζ_{g} and ζ_{\tilde{g}}The optimization problem may be expressed as shown in Equation 58.

$${min}_{\begin{matrix}{u}_{ξ} , {u}_{\tilde{θ}} , B \\ s . t . ( C \text{.1} )\end{matrix}} {ζ}_{ξ} tr ( T ( {u}_{ξ} ) ) + {ζ}_{\hat{θ}} tr ( T ( {u}_{\hat{θ}} ) ) + {‖ {\tilde{Y}}_{v} {X}_{v}^{- 1} - B ‖}_{F}^{2} , \qquad [ Equation 58 ]$$

Here, ζ_{ξ}∝\sqrt{(σ²/ρ)M log(M)} and ζ_{\tilde{θ}}∝\sqrt{(σ²/ρ)Nᵤ log(Nᵥ)} may be determined based on a dimensionality of the problem and a state of the noise. The above-mentioned problem can be directly solved using optimization tools such as CVX or SeDuMi. After solving Equation 58, ξ_{g,1} and \tilde{θ}₁ can be estimated from the two vectors u_{ξ} and u_{θ}, obtained using matrix decomposition or root-finding techniques based on the two-dimensional frequency measurements of B.

Meanwhile, the base station may estimate the gain components of the vertical and horizontal channels from the reception signal by performing linear estimation using the angle information (i.e. AoA and AoD). Furthermore, the base station may estimate the Doppler shift components for calculating a ratio of channel gains obtained in the vertical and horizontal directions using the angle information (i.e. AoA and AoD). In other words, the base station may calculate the gain of the vertical-direction channel and the gain of the horizontal-direction channel using the AoA and AoD. Additionally, the base station may calculate the Doppler shift component of the vertical-direction channel and the Doppler shift component of the horizontal-direction channel using the AoA and AoD.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
configuring a reflection pattern in which reflective elements in at least one row of a reconfigurable intelligent surface (RIS) node are activated during a unit time, and then reflective elements in at least one column of the RIS are activated during a unit time;
transmitting configuration information on the reflection pattern to the RIS node;
receiving, from the RIS node, signals including pilot symbols reflected according to the configured reflection pattern;
separating the signals received during the unit time into first reception signals in a first direction and second reception signals in a second direction;
estimating a first channel in the first direction by using the first reception signals;
estimating a second channel in the second direction by using the second reception signals; and
detecting a direction of the RIS node using the first channel and the second channel.

2. The method according to claim 1, wherein the reflection pattern is a pattern formed by sequentially activating the reflective elements in the at least one row of the RIS node while shifting in the first direction, and then sequentially activating the reflective elements in the at least one column of the RIS node while shifting in the second direction.

3. The method according to claim 1, wherein the first reception signals are signals reflected by the reflective elements in the at least one row of the RIS node during the unit time, and the second reception signals are signals reflected by the reflective elements in the at least one column of the RIS node during the unit time.

4. The method according to claim 1, wherein the base station estimates the first channel from the first reception signals and estimates the second channel from the second reception signals by using one of an atomic norm minimization technique, a multiple signal classification (MUSIC) algorithm, or a root-MUSIC algorithm.

5. The method according to claim 1, wherein the detecting of the direction of the RIS node comprises:
calculating angles of arrivals (AoAs) of signals received from the RIS node using the first channel and the second channel;
calculating effective angles of departure (AoDs) at the RIS node for the signals received from the RIS node using the first channel and the second channel; and
detecting the direction of the RIS node using the AoAs and the AoDs.

6. The method according to claim 5, wherein the base station calculates the AoAs and the AoDs from the first channel and the second channel using one of a single component analysis algorithm, a MUSIC algorithm or a root-MUSIC algorithm.

7. The method according to claim 5, further comprising: calculating a gain for the first channel and a gain for the second channel using the AoAs and the AoDs.

8. The method according to claim 5, further comprising: estimating a Doppler shift component for the first channel and a Doppler shift component for the second channel using the AoAs and the AoDs.

9. A base station comprising a processor, wherein the processor causes the base station to perform:
configuring a reflection pattern in which reflective elements in at least one row of a reconfigurable intelligent surface (RIS) node are activated during a unit time, and then reflective elements in at least one column of the RIS are activated during a unit time;
transmitting configuration information on the reflection pattern to the RIS node;
receiving, from the RIS node, signals including pilot symbols reflected according to the configured reflection pattern;
separating the signals received during the unit time into first reception signals in a first direction and second reception signals in a second direction;
estimating a first channel in the first direction by using the first reception signals;
estimating a second channel in the second direction by using the second reception signals; and
detecting a direction of the RIS node using the first channel and the second channel.

10. The base station according to claim 9, wherein the reflection pattern is a pattern formed by sequentially activating the reflective elements in the at least one row of the RIS node while shifting in the first direction, and then sequentially activating the reflective elements in the at least one column of the RIS node while shifting in the second direction.

11. The base station according to claim 9, wherein the first reception signals are signals reflected by the reflective elements in the at least one row of the RIS node during the unit time, and the second reception signals are signals reflected by the reflective elements in the at least one column of the RIS node during the unit time.

12. The base station according to claim 9, wherein the base station estimates the first channel from the first reception signals and estimates the second channel from the second reception signals by using one of an atomic norm minimization technique, a multiple signal classification (MUSIC) algorithm, or a root-MUSIC algorithm.

13. The base station according to claim 9, wherein in the detecting of the direction of the RIS node, the processor causes the base station to perform:
calculating angles of arrivals (AoAs) of signals received from the RIS node using the first channel and the second channel;
calculating effective angles of departure (AoDs) at the RIS node for the signals received from the RIS node using the first channel and the second channel; and
detecting the direction of the RIS node using the AoAs and the AoDs.

14. The base station according to claim 13, wherein the base station calculates the AoAs and the AoDs from the first channel and the second channel using one of a single component analysis algorithm, a MUSIC algorithm or a root-MUSIC algorithm.
